(19) United States
(12) Patent Application Publication
(10) Pub. No.: US 2010/0146306 A1
(43) Pub. Date: Jun. 10, 2010

(54) Retail display system and low power, bi-stable wireless monitor for use therein

(76) Inventor: Edward Neipris, Foxboro, MA (US)

Correspondence Address: KRIEGSMAN & KRIEGSMAN, 30 TURNPIKE ROAD, SUITE 9, SOUTHBOROUGH, MA, 01772, US

(21) Appl. No.: 12/592,281

(22) Filed: Nov. 20, 2009

Related U.S. Application Data
(60) Provisional application No. 61/199,768, filed on Nov. 20, 2008.

(51) Int. Cl. G06F 3/048; G06F 1/26; G06F 15/16

(52) U.S. Cl. 713/300; 715/733

(57) ABSTRACT

A retail display system includes a centralized hub and a local retail facility. The centralized hub includes a hub server that independently communicates with a local server at the retail facility. In turn, the retail facility includes a plurality of wireless monitors that communicate with its local server. In this manner, each monitor is capable of wirelessly receiving a bundle of display events from the hub server via the local server, each display event instructing certain monitors to display a particular image at a specific time. To limit its power consumption, each monitor includes a display capable of retaining an image in the absence of power, such as a bi-stable LCD, and is configured to activate either to scan and receive display event updates or to comply with the next scheduled display event. As a result of its limited power requirement, each monitor is powered primarily using ambient solar energy.

### CROSS-REFERENCE TO RELATED APPLICATIONS

The present application claims the benefit under 35 U.S.C. 119(e) of U.S. provisional Patent Application Ser. No. 61/199,768, filed Nov. 20, 2008, the disclosure of which is incorporated herein by reference.

### BACKGROUND OF THE INVENTION

In the retail industry, display signs are commonly utilized to provide sales information relating to articles of commerce. For example, in the retail clothing industry, articles of clothing are often displayed together on racks. Sales information relating to articles hung on a particular rack is commonly conveyed by providing a display sign in close proximity to the rack (e.g., directly above the center of the rack).

One type of display sign that is well known in the art comprises a rigid frame (commonly constructed of metal or plastic) that is designed to removably receive a sign, or card, through an open slot. Each sign is typically constructed of a paper-backed material and includes sales information printed on at least one of its primary surfaces (e.g., 2-for-1 sale, 30% off, etc.). In this manner, by printing a wide variety of different signs, retailers can notify their customers of changes in sales offerings by swapping different sales cards from each frame.

It has been found that the use of paper-based display signs introduces a couple notable drawbacks.

As a first drawback, in many outlet-style retail environments, a large quantity of display signs are utilized to convey pertinent information relating to articles available for purchase. Furthermore, retailers frequently modify sales offerings to stimulate business. Accordingly, it has been found that a relatively large quantity of display cards require frequent replacement in order to meet the display needs of retailers. As a result, many workers are presently required to manually change a large number of display cards from their associated frames during off-peak hours, thereby significantly increasing labor costs, which is highly undesirable.

As a second drawback, the process of printing a considerable quantity of paper-based display signs is not only environmentally disadvantageous but also costly and time-consuming as well.

In response to some of the shortcomings set forth above in connection with paper-based display cards, it is known in the retail industry to use digital displays to convey pertinent sales information, such as product pricing information.

Digital displays used in retail settings typically remain continuously powered for extended periods of time and, as such, require a considerable amount of power. Accordingly, digital displays used in retail applications commonly derive power using either a direct line connection to a traditional electrical outlet or a portable battery source. As can be appreciated, both aforementioned means for powering digital displays introduces notable shortcomings.

Specifically, the use of a direct line connection of each display to a traditional outlet introduces a considerable degree of wiring in the immediate sales floor area. The presence of wiring on the sales floor has been found to be obtrusive and unsightly, which is highly undesirable.

Furthermore, the use of a portable battery-driven power source significantly limits the active lifespan of the monitor unless frequent battery replacement is undertaken. As can be appreciated, frequent battery replacement is not only expensive but also labor-intensive, which is highly undesirable.

Finally, it should be noted that the content provided on digital displays used in retail environments is traditionally input at a local level. As an example, for a chain of retail stores, price information associated with a product offered for sale at multiple retail locations must be input into the digital display at the store level by local management. Because pricing decisions are traditionally determined by upper-level management at the enterprise, or chain, level, a multi-stepped process is thereby required in which upper-level centralized management informs each local retail store of pricing information. In turn, local management modifies local digital displays in accordance with the chain-level management instructions. As can be appreciated, this multi-stepped process has been found to be both inefficient and error-prone, which is highly undesirable.

### SUMMARY OF THE INVENTION

It is an object of the present invention to provide a new and improved retail display system and monitor for use therein.

It is another object of the present invention to provide a retail display system and monitor as described above wherein the retail display system is configured to facilitate the communication and regulation of display information from a centralized, chain-level management facility to one or more local retail stores.

It is yet another object of the present invention to provide a retail display system and monitor as described above wherein the monitor includes a digital display.

It is still another object of the present invention to provide a retail display system and monitor as described above wherein the monitor is wirelessly enabled and requires a limited amount of power.

Accordingly, as one feature of the present invention, there is provided a display system, comprising (a) a centralized hub, the centralized hub comprising a hub server, and (b) a local facility located remotely from the centralized hub, the local facility comprising, (i) a local server in communication with the hub server, and (ii) one or more display devices in communication with the local server, (iii) wherein each display device is configured to operate in compliance with one or more display events received by the local server, each display event requesting that a particular image file be displayed on one or more designated display devices at a specific moment in time, the information associated with each display event being stored in the hub server.

As another feature of the present invention, there is provided a display device adapted to receive one or more designated display events, each display event including data relating to the display of a particular image by the display device at a specified moment in time, the display device comprising (a) a no-power image retention display for displaying an image in accordance with each display event, (b) electronics for regulating operation of the no-power image retention display in accordance with each display event, the electronics comprising, (i) a central processing unit (CPU) for controlling the general operation of the display device, (ii) a display driver electrically connecting the CPU to the no-power image retention display, the display driver regulating the image displayed by the no-power image retention display in response to display instructions received from the CPU, (iii) a real time clock and calendar (RTCC) connected to the CPU for monitoring real time, (iv) a wireless connector connected to the CPU for receiving information associated with display events designated for the display device, and (v) memory connected to the CPU for storing information associated with display events designated for the display device, and (c) a power system for supplying power to the display device.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate an embodiment of the present invention and, together with the description, serve to explain the principles of the invention. In the drawings, wherein like reference numerals represent like parts:

FIG. 1 is a simplified block diagram of a novel display system constructed according to the teachings of the present invention;

FIG. 2 is a front perspective view, broken away in part, of one of the display devices shown in FIG. 1; and

FIG. 3 is a simplified block diagram of selected components of the display device shown in FIG. 2.

### DETAILED DESCRIPTION OF A PREFERRED EMBODIMENT

### Overview of Display System 11

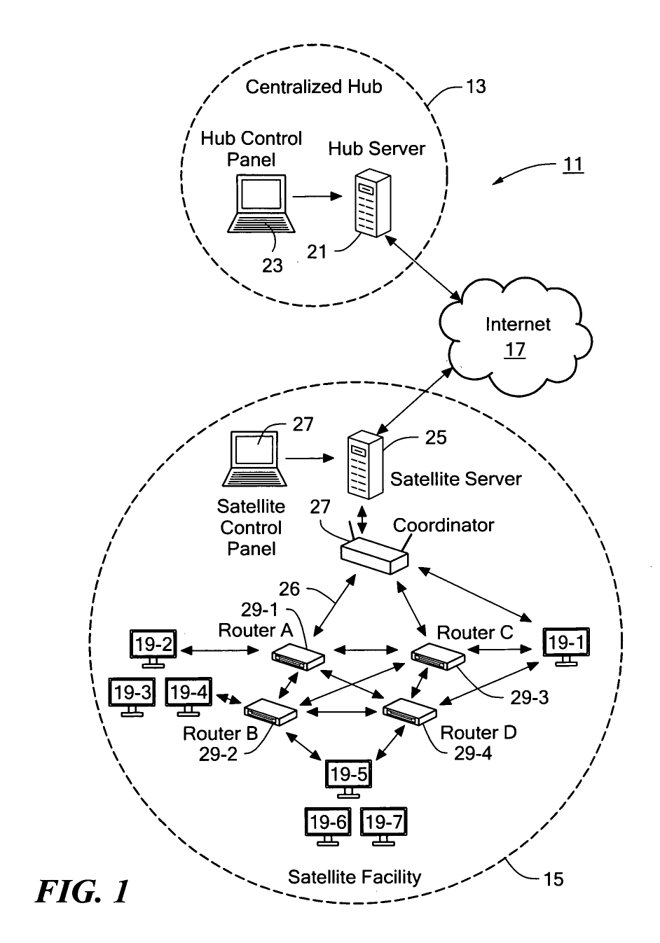

Referring now to FIG. 1, there is shown a simplified block diagram of a novel display system, the novel display system being constructed according to the teachings of the present invention and identified generally by reference numeral 11.

As can be seen, display system 11 comprises a centralized hub 13 and at least one remotely located satellite, or local, retail facility 15 that are electronically linked via the internet 17. As will be described in detail below, each satellite facility 15 is provided with a plurality of individual, low power, semi-static display devices, or monitors, 19 that are configured to present dynamically modifiable sales and/or advertising information relating to articles of commerce available for purchase at satellite facility 15, which is highly desirable.

For purposes of simplicity only, display system 11 is represented herein as comprising a single satellite facility 15 in electronic communication with centralized hub 13. However, it is to be understood that display system 11 preferably includes a plurality, or retail chain, of remotely located satellite facilities that are independently linked to centralized hub 13 via the internet 17.

Centralized hub, or enterprise, 13 operates as the control center for display system 11 and is responsible for, inter alia, regulating the majority of the graphical content displayed on each monitor 19 in each satellite facility 15 linked thereto. In this manner, a single centralized HUB 13 can regulate in an automated and near-instantaneous fashion the information displayed on every display device 19 throughout an entire chain of retail stores. Accordingly, due to its importance within system 11, it is envisioned that centralized hub 13 be located at a data secure facility, such as a corporate headquarters. However, it is to be understood that hub 13 could be located in any global location with internet accessibility without departing from the spirit of the present invention.

Centralized hub 13 comprises a hub, or enterprise, server 21 in bidirectional electronic communication with the internet 17. Server 21 is responsible for, among other things, storing and transmitting data associated with all scheduled display events (i.e, maintaining a master database of display event data). As defined herein, use of the term “display event” relates to the request, or order, to display a particular image on one or more designated monitors at a specific moment in time.

A hub, or enterprise, control panel 23 is linked in electronic communication with hub server 21 and is represented herein as any well known compute device, such as a laptop computer. Preferably, control panel 23 is programmed with software that provides a graphical front end for data entry personnel to easily input, modify and/or review all of the necessary information that is required to execute display events across global, regional, local and/or display device specific levels. In turn, the display event data input through hub control panel 23 is stored in hub server 21 (or in a separate database linked thereto). In this manner, the data associated with each display event is available for retrieval on a global scale by each satellite facility 15.

Preferably, the types of information input into hub server 21 through control panel 23 includes, among other things, (i) image information—which relates to collection and organization of the various images files to be displayed on monitors 19, (ii) inventory information—which relates to the collection and organization of inventory available at each retail facility 15, the inventory information being organized by, inter alia, geographic location (e.g., all northeast retail facilities 15), specific retail facilities, a specific department within one or more retail facilities and/or a sub-department within one or more retail facilities (e.g., a particular brand of children's shoes), (iii) display device information—which relates to the collection and organization of the unique identification code associated with each monitor 19 in system 11 in relation to its placement within its corresponding local facility 15 (e.g., monitor X is located at the end of the children's shoes rack Y in retail store Z), and (iv) display event information—which relates to, inter alia, the particular image file, designated display devices and start time associated with each display event.

As can be seen, each satellite, or local, facility 15 similarly comprises a satellite, or local, server 25 in bidirectional electronic communication with the internet 17. In use, local server 25 serves to retrieve and store local display events (i.e., events tagged for execution at local facility 15) from hub server 21. In this manner, local server 25 compiles a database of local display events for local facility 15.

Preferably, a satellite, or local, control panel 27 is linked in electronic communication with local server 25 and is represented herein as any well known compute device, such as a laptop computer. Local control panel 27 is preferably provided with the same software installed on hub control panel 23. In this manner, control panel 27 provides authorized local management with a graphical front end to review and, when necessary, modify local display events (e.g., to temporarily extend the duration of a local sale due to excess inventory).

As noted briefly above, satellite facility 15 preferably includes a plurality of individual display devices, or monitors, 19-1 thru 19-7 that are configured to present modifiable information (e.g., sales information) in accordance with the scheduled display events. To facilitate the transmission of information from local server 25 to monitors 19, an intermediate local network 26 is preferably provided. Local network 26 is preferably in the form of a simple, secure, reliable, low data rate control network that is designed to both (i) conserve power (e.g., by using a limited transmission range), and (ii) operate in a mesh topology in order to provide multiple pathways for transferring data, thereby ensuring data delivery to monitors 19 if any intermediary device, or node, is temporarily disabled or removed. For example, local network 26 may be implemented using a ZigBee® wireless network.

A network coordinator 27 is directly linked in electronic communication with local server 25. As can be appreciated, network coordinator 27 serves as a gateway between local server 25 and network 26 and is responsible for, inter alia, (i) creation of local network 26, (ii) allocation of an address for each device in local network 26, and (iii) conversion of radio frequency protocol traffic (e.g., 803.15.4 traffic) to internet protocol (IP) traffic.

It should be noted that for a local facility 15 with a relatively large network, coordinator 27 may be incapable of effectively transmitting data to both local server 25 and local network 26. Accordingly, although not shown herein, an additional gateway device may be disposed between local server 25 and coordinator 27, the additional gateway device being primarily responsible for communication with local server 25. As a result, coordinator 27 is effectively limited to the transmission of data to network 26.

A plurality of wireless routers 29-1 thru 29-4 (also referred to herein routers A thru D) is linked, directly or indirectly, to network coordinator 27. Together, routers 29 create an expanded wireless network with which each display device 19 can communicate. As a result of the wireless network, monitors 19 are able to receive display event information without the use of complex and obtrusive wiring on the sales floor, which is a principal object of the present invention.

It should be noted that four individual routers 29 are provided herein to enhance communication between network coordinator 27 and the plurality of display devices 19. However, it is to be understood the particular number and arrangement of routers 29 could be modified without departing from the spirit of the present invention to (i) alter the physical range of local network 26 and/or (ii) resolve topology issues specific to a particular network. For example, it is to be understood that routers 29 may be eliminated entirely from a local facility 15 dimensioned to operate efficiently using a limited range network, with coordinator 27 transmitting display event information directly to each monitor 19.

It should also be noted that the plurality of routers 29 and display devices 19 is configured to communicate with one another utilizing a mesh topology. In this manner, if a single router 29 or monitor 19 is temporarily disabled or removed from local network 26, the remaining monitors 19 are not precluded from receiving pertinent display event data.

In the present invention, seven individual display devices 19 are shown. As will be described further in detail below, each display 19 is preferably assigned to one or more specific articles of commerce available at retail facility 15. For example, a single individual display device (e.g., display device 19-1) may be a designated to display information relating to a particular brand of mens shirts and, as such, is preferably positioned in close proximity thereto (e.g., directly above a rack of said shirts). Accordingly, it is to be understood that the number and arrangement of display devices 19 can be modified to meet the particular needs of each facility 15 without departing from the spirit of the present invention.

### Construction of Display Device 19

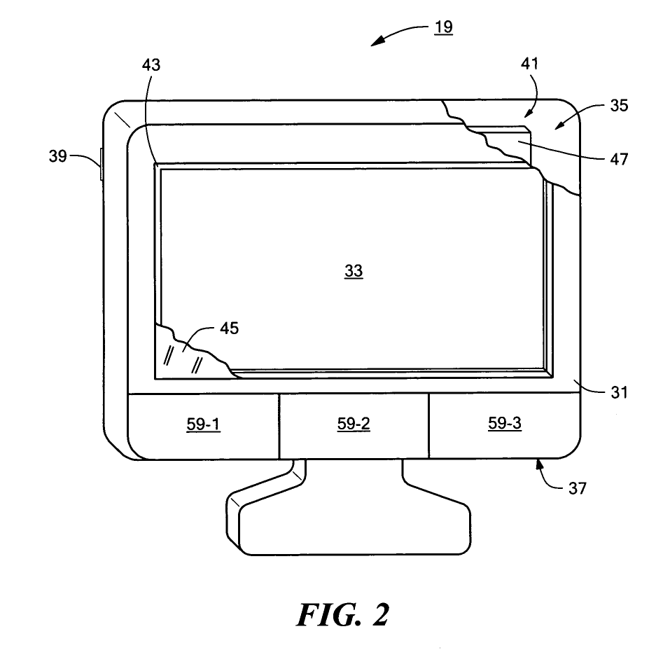

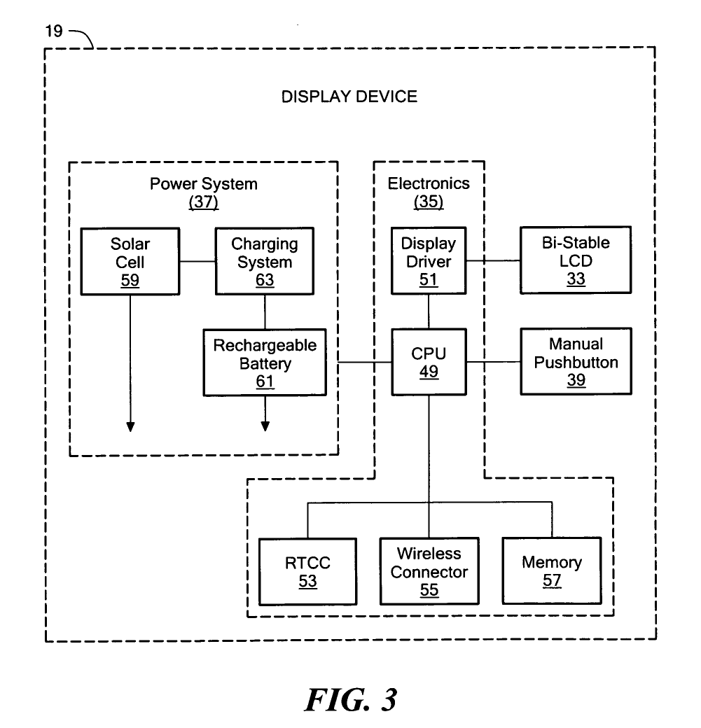

Referring now to FIGS. 2 and 3, there are shown front perspective and simplified schematic views, respectively, of a single display device 19. As will be described in detail below, display device 19 is specifically designed to minimize its power consumption requirement. Accordingly, the construction of display device 19 as well as its operation within system 11 serve as novel features of the present invention.

As can be seen, display device 19 comprises, inter alia, an outer housing, or casing, 31, a bi-stable liquid crystal display 33 disposed within housing 31, electronics 35 for regulating operation of display 33, a power system 37 for supplying power to electronics 35 and an externally-accessible pushbutton 39 for manually activating electronics 35.

Housing 31 is preferably constructed from multiple rigid and durable plastic segments that are hermetically sealed together, such as through ultrasonic welding. Together, the joined plastic pieces define an interior cavity 41 into which selected components of device 19 are disposed. Preferably, a window, or opening, 43 is formed into the front of housing 31 that enables display 33 to be externally viewable.

It should be noted that housing 31 is represented herein as being in the size and shape of a traditional computer monitor. However, it is to be understood that the particular configuration of housing 31 could be modified to meet the needs of its intended usage without departing from the spirit of the present invention.

Display 33 is preferably a bi-stable, monochrome, reflective liquid crystal display (LCD) that is disposed within interior cavity 41 of housing 31 and is positioned such that its display screen aligns within window 43 for external viewing. Due to its bi-stable design, display 33 is characterized as, inter alia, being able to retain a static image indefinitely without power.

Specifically, the display crystals for display 33 exist in either one of two stable orientations (e.g., black or green). As can be appreciated, power is only required by display 19 in order to change the image provided, thereby significantly reducing its lifetime power consumption requirement, which is a principal object of the present invention.

It should be noted that display 33 represents any known type of no-power image retention display. As an example, display 33 may be derived from any no-power graphic display LCD module sold and manufactured by Kent Displays, Inc. of Kent, Ohio under its Reflex®-line of LCD modules.

It should also be noted that display 33 may be constructed in any known size (e.g., 1″ by 3″, 4″ by 6″, 8″ by 11″, etc.) and/or resolution (e.g., 72 dpi, 85 dpi, etc.) without departing from the spirit of the present invention.

As seen most clearly in FIG. 2, a front cover 45 constructed of a rigid, durable and transparent plastic material, such as acrylic or polycarbonate, is preferably provided to protect the sensitive components of display 33, front cover 45 being either directly integrated into the construction of display 33 or constructed separately from display 33 and in turn independently mounted onto housing 31 within window 43. As can be appreciated, the construction of front cover 45 is preferably designed to maximize protection and visibility of display 33. For example, it is preferred that an ultraviolet (UV) blocking material be applied to front cover 45 to protect the liquid crystal materials of display 33 from potentially harmful UV light. As another example, it is preferred that an anti-glare and/or anti-reflective surface film or finish be applied to front cover 45 to improve the optical performance of display 33 in certain applications and lighting conditions.

As noted above, display device 19 includes electronics 35 for regulating the principal operation of bi-stable LCD 33. For greater ease in manufacture, it is preferred that the various components of electronics 35 be mounted on a common printed circuit board (PCB) 47 that is disposed within interior cavity 35 of housing 31 in electrical connection with bi-stable LCD 33.

As seen most clearly in FIG. 3, electronics 35 comprises a central processing unit (CPU) 49 for controlling the principal operations of display device 19, a display driver 51 for regulating the image displayed on bi-stable display 33, a real time clock and calendar (RTCC) 53 for monitoring real time, a wireless connector 55 for providing device 19 with wireless communication capabilities and memory 57 for retaining display event data for device 19.

CPU 49 represents any conventional, low-power, programmable microcontroller that is suitable for use in the present application. As noted above, CPU 49 regulates most of the principal operations of display device 19 including, but not limited to, the particular power mode, or state, of device 19 (i.e., in either its active mode and or its sleep mode).

Display driver 51 electrically connects CPU 49 to bi-stable LCD 33 and is programmed to regulate operation of bi-stable LCD 33 (e.g., the image provided by LCD 33) in response to commands provided by CPU 49.

Real time clock and calendar (RTCC) 53 is electrically connected to CPU 49 and is responsible for monitoring time. Accordingly, it is to be understood that RTCC 53 operates in conjunction with CPU 49 to activate display device 19 from its sleep mode at defined time intervals (e.g., to modify LCD 33 or check for display event updates). Although RTCC 53 is represented herein as being separate from CPU 49, it is to be understood that RTCC 53 could be directly integrated into CPU 49 without departing from the spirit of the present invention.

Wireless connector 55 is electrically connected to CPU 49 and effectively enables CPU to wireless communicate with local network 26 (e.g., to receive relevant display events). Preferably, wireless connector 55 is capable of ZigBee® communication with local network 26.

Memory 57 is electrically connected to CPU 49 and is provided to store data relating to one or more display events. For example, memory 57 may be in the form of a 1 MB flash memory device that is capable of storing up to ten display events for device 19.

As noted above, display device 19 also includes a power system 37 for supplying device 19 with the necessary power to operate. As will be described further in detail below, display device 19 functions in either (i) an active (i.e., powered) mode or (ii) an inactive, or sleep, (i.e., no-power) mode, the duration of its sleep mode being maximized to limit its power consumption.

Power system 37 is electrically connected to CPU 49 and comprises two separate sources for supplying power to display device 19. Specifically, power system 37 comprises at least one solar cell 59 and at least one battery 61, each of which is electrically connected to a common charging system 63 that includes a device (e.g., a supercapacitor) for harvesting and storing the energy produced by said sources.

Solar cells 59 preferably serve as the primary source of power for power system 37. As seen clearly in FIG. 2, solar cells 59 are arranged as a horizontal array of individual solar panels 59-1, 59-2 and 59-3 that are disposed along the exterior of the front of housing along its bottom edge. In use, solar cells 59 convert ambient light sources (e.g., solar, incandescent and florescent light) into electrical energy that is stored in charging system 63. As presently designed, solar cells 59 generate enough power to support nearly all operation of display device 19.

Battery 61 serves as the secondary, or back-up, source of power for power system 37. Specifically, charging system 63 measures its stored power level which is, in turn, monitored by CPU 49. If the power level of charging system 63 falls beneath a predetermined threshold, CPU 49 directs charging system 63 to temporarily draw power from batteries 61, as deemed necessary (i.e., as an emergency back-up power source).

It should be noted that battery 61 can either be of the rechargeable or non-rechargeable variety. If a rechargeable battery is utilized, it is envisioned that recharging be accomplished using energy stored in charging system 63. If a non-rechargeable battery is utilized, it is envisioned that a removable panel be incorporated into the rear of housing 31 to allow for battery replacement when necessary.

As noted above, display device 19 also includes a pushbutton 39 for manually activating display device 19 from its sleep mode. Pushbutton 39 is mounted onto the rear of housing 31 in an inconspicuous, externally accessible manner and is electrically connected to CPU 49. As will be described further below, manual depression of pushbutton 39 immediately activates display device 19 from its sleep mode (i.e. prior to its next scheduled action monitored by RTCC 53).

Although not shown herein, it is to be understood that a unique identification code is preferably designated for each monitor 19 and is readily available for automatic retrieval. For example, the unique ID code may be represented as a barcode printed on a label that is in turn affixed to the rear of housing 31. In this manner, a central database can be created in hub server 21 that cross-references each individual monitor 19 with the collection of display events associated therewith.

### Overview of System Operation

In use, system 11 operates in the following manner. As a preliminary step, each monitor 19 must first be integrated into display system 11 through an initialization process. Specifically, a handheld scanner (or other similar auto-ID device) is used to retrieve the unique identification code provided on the rear of housing 31. In addition, the scanner is used to automatically retrieve a product identification number associated with an article of commerce with which the specific display device 19 is to be linked (e.g., a SKU number provided on a merchandise tag affixed to the product). Through this process, server 21 is able to link the particular monitor 19 with a certain piece of inventory and, as such, determine its relative location within a specific retail facility 15.

Because display device 19 is normally powered off to conserve energy, monitor 19 is initially activated by manually depressing pushbutton 39. Having been activated, CPU 49 energizes wireless connector 55 and retrieves from network 26 the serial number, or version, of the most recent bundle of display events received by local server 25 that is designated for the particular display device 19. Because display device 19 is not initially provided with any display events, CPU 49 retrieves the data bundle, stores the data associated with the collection of display events in memory 57 and immediately powers down.

It should be noted that a plurality of events (e.g., 10 events) is preferably included in each data bundle in order to protect against temporary lapses, or interruptions, in network 26 (e.g., due to an unforseen power outage). As a result, it is envisioned that each display 19 can be fully operational over an extended period of time without access to network 26, which is highly desirable.

With display device 19 powered down, RTCC 53 monitors both (i) the time-stamp associated with the next scheduled display event stored in memory 57 as well as (ii) the next scheduled scan from network 26 for display event updates (i.e., display device 19 is preferably programmed to scan network 26 at predetermined, fixed time intervals, such as every 10 minutes, for data bundle updates).

If the time-stamp associated with a scheduled display event stored in memory 57 is detected, RTCC 53 wakes display device 19 from its sleep mode. Having determined that the next display event is now in effect, CPU 49 transmits the stored image file associated with the display event to display driver 51 which, in turn, applies the image file to bi-stable LCD 33. With the image now displayed on LCD 33, CPU 49 (i) transmits configuration and monitoring logs to local server 25 (which, in turn, transmits the data to HUB server 21) and (ii) returns display device 19 to its sleep mode, with the new image being retained on LCD 33 in the absence of power.

If the next scheduled display event update scan is detected (e.g., if 10 minutes have lapsed since the last update scan), RTCC 53 wakes display device 19 from its sleep mode. In turn, CPU 49 recognizes that an update scan is required. Accordingly, CPU 49 energizes wireless connector 55 and retrieves from a node on network 26 (e.g., from router 29-1) the serial number, or version, of the most recent bundle of display events received by local server 25 that is designated for device 19. If display device 19 has received the most recent display event bundle, CPU 49 immediately returns device 19 to its sleep mode. If display device 19 has not received the most recent display event bundle, CPU 49 retrieves the new data bundle, stores the data associated with the collection of display events in memory 57 and then immediately powers down until the next scheduled activation.

Preferably, display device 19 is programmed to scan for display event updates in a relatively frequent manner (e.g., every 10 minutes). As such, this enables local management, if properly authorized, to quickly disseminate information to customers using display devices 19. For example, if authorized local management determines a surplus of inventory in a particular department, near-immediate notification of a limited-time sale of the inventory can be executed using display devices 19, which is highly desirable. In this situation, it should be noted that the local override instruction input into local server 25 through satellite control panel 27 is copied and sent back to hub server 21 for centralized review.

As noted above, each device 19 is programmed to scan for updates at predetermined time intervals. However, it should be noted that an immediate update scan can be accomplished by manually depressing pushbutton 39. By actuating pushbutton 39, CPU 49 instantly activates display device 19 from its sleep mode and immediately scans for display event updates.

It should be noted that each revised bundle of display events is preferably device-specific. Stated another way, each display device 19 is designed to receive its own bundle of display events. By creating device-specific updates, the transmission of data across network 16 is staggered, thereby reducing network traffic issues that may arise if all display devices 19 were to simultaneously retrieve a common update bundle from network 26.

As noted above, system 11 is configured to operate in such a manner so as to minimize the power consumption requirement of each device 19. Specifically, the use of bi-stable LCD 33 allows for image retention on each monitor 19 without power. Furthermore, as set forth above, each monitor 19 remains primarily in its powered down state and only temporarily activates either (i) to scan for updates and/or (ii) change the image displayed on bi-stable LCD 33 in accordance with a display event. As a result of its lower power consumption requirement, each device 19 can be powered primarily using ambient light, thereby eliminating the need for an obtrusive wired connection to an electrical outlet and/or a significant battery power requirement.

The embodiment of the present invention described above is intended to be merely exemplary and those skilled in the art shall be able to make numerous variations and modifications to them without departing from the spirit of the present invention. All such variations and modifications are intended to be within the scope of the present invention as defined in the appended claims.

What is claimed is:

1. A display system, comprising:
(a) a centralized hub, the centralized hub comprising a hub server, and
(b) a local facility located remotely from the centralized hub, the local facility comprising,
(i) a local server in communication with the hub server, and
(ii) one or more display devices in communication with the local server,
(iii) wherein each display device is configured to operate in compliance with one or more display events received by the local server, each display event requesting that a particular image file be displayed on one or more designated display devices at a specific moment in time, the information associated with each display event being stored in the hub server.

2. The display system as claimed in claim 1 wherein the information associated with each display event is input into the hub server using a hub control panel in electronic communication therewith.

3. The display system as claimed in claim 2 wherein a compilation of display events designated for the local facility is stored on the local server.

4. The display system as claimed in claim 4 further comprising a local control panel in electronic communication with the local server, the compilation of display events designed for the local facility being available for review and modification using the local control panel.

5. The display system as claimed in claim 1 wherein the one or more display devices communicate with the local server through a local network.

6. The display system as claimed in claim 5 wherein the local network is wireless network designed to operate in a mesh topology.

7. The display system as claimed in claim 6 wherein the local facility further comprises:
(a) a network coordinator in direct communication with the local server, and
(b) at least one wireless router in communication with the network coordinator.

8. The display system as claimed in claim 1 wherein each display device comprises:
(a) a no-power image retention display for displaying an image in accordance with each display event designated for the display device,
(b) electronics for regulating operation of the no-power image retention display in accordance with each display event designated for the display device, and
(c) a power system for supplying power to the electronics.

9. The display system as claimed in claim 8 wherein each display device operates in either an active power mode or an inactive power mode.

10. The display system as claimed in claim 9 wherein each display device is normally disposed in its inactive power mode.

11. The display system as claimed in claim 10 wherein each display device temporarily switches to its active power mode to scan for display event updates designated for the display device.

12. The display system as claimed in claim 10 wherein each display device temporarily switches to its active power mode to modify the image displayed on the no-power image retention display in accordance with a scheduled display event for the display device.

13. The display system as claimed in claim 8 wherein the no-power image retention display for each display device is in the form of a bi-stable liquid crystal display (LCD).

14. The display system as claimed in claim 9 wherein the electronics for each display device comprises:
(a) a central processing unit (CPU) for controlling the general operation of the display device,
(b) a display driver electrically connecting the CPU to the no-power image retention display, the display driver regulating the image displayed by the no-power image retention display in response to display instructions received from the CPU,
(c) a real time clock and calendar (RTCC) connected to the CPU for monitoring real time,
(d) a wireless connector connected to the CPU for receiving information associated with display events designated for the display device, and
(e) memory connected to the CPU for storing information associated with display events designated for the display device.

15. The display system as claimed in claim 9 wherein the power system for each display device comprises:
(a) a primary power source, the primary power source comprising at least one solar cell,
(b) a secondary power source, the secondary power source comprising at least one battery, and
(c) a charging system connected to the primary and secondary power sources for harvesting energy produced thereby, the charging system continuously drawing power from the primary power source, the charging system drawing power from the secondary power source only if the measured stored power level falls beneath a predefined threshold.

16. The display system as claimed in claim 9 wherein each display device additionally comprises an outer housing for protecting selected components of the display device.

17. The display system as claimed in claim 16 wherein each display device additionally comprises an externally accessible pushbutton connected to the electronics for manually activating the display device from its inactive mode.

18. A display device adapted to receive one or more designated display events, each display event including data relating to the display of a particular image by the display device at a specified moment in time, the display device comprising:
(a) a no-power image retention display for displaying an image in accordance with each display event,
(b) electronics for regulating operation of the no-power image retention display in accordance with each display event, the electronics comprising,
(i) a central processing unit (CPU) for controlling the general operation of the display device,
(ii) a display driver electrically connecting the CPU to the no-power image retention display, the display driver regulating the image displayed by the no-power image retention display in response to display instructions received from the CPU,
(iii) a real time clock and calendar (RTCC) connected to the CPU for monitoring real time,
(iv) a wireless connector connected to the CPU for receiving information associated with display events designated for the display device, and
(v) memory connected to the CPU for storing information associated with display events designated for the display device, and
(c) a power system for supplying power to the display device.

19. The display device as claimed in claim 18 wherein the no-power image retention display is in the form of a bi-stable liquid crystal display (LCD).

20. The display device as claimed in claim 18 wherein the power system comprises:
(a) a primary power source, the primary power source comprising at least one solar cell,
(b) a secondary power source, the secondary power source comprising at least one battery, and
(c) a charging system connected to the primary and secondary power sources for harvesting energy produced thereby, the charging system continuously drawing power from the primary power source, the charging system drawing power from the secondary power source only if the measured stored power level falls beneath a predefined threshold.
